(19) United States
(12) Patent Application Publication
(10) Pub. No.: US 2004/0163214 A1
(43) Pub. Date: Aug. 26, 2004

(54) Assist handle for electric tools

(75) Inventor: Chih Ming Cheng, Taiping City (TW)

Correspondence Address: BACON & THOMAS, PLLC, 625 SLATERS LANE, FOURTH FLOOR, ALEXANDRIA, VA, 22314

(73) Assignee: MOTOMAX ELECTRIC CO., LTD., Taiping City (TW)

(21) Appl. No.: 10/372,141

(22) Filed: Feb. 25, 2003

(51) Int. Cl. B62B 1/00

(52) U.S. Cl. 16/426

(57) ABSTRACT

An assist handle for electric tools includes a handle having a connection member on an end thereof and a clamp member is pivotably connected to the connection member. The clamp member has a hole for clamping the tool therein and a trigger is pivotably connected to the clamp member. The trigger has a tongue which is removably engaged with a notch in the connection member. A passage is defined in communication between the hole of the clamp member and a space between the two extensions. A locking member is received in the passage and a top end of the connection member urges against the locking member toward the tool in hole. The tongue is removed from the notch by pivoting the trigger and the handle is rotated laterally to release the pressure on the locking member so that the clamp member can be conveniently rotated an angle.

### FIELD OF THE INVENTION

The present invention relates to an assist handle for electric tools and the assist handle is easily released and re-tightened again so as to quickly adjust its orientation.

### BACKGROUND OF THE INVENTION

A conventional assist handle 10 for electric tools is shown in FIGS. 1 and 2 and generally includes a handle 11 with a C-shaped clamp member 12 connected on a top thereof and a barrel of a electric tool 20 is clamped in the clamp member 12 by using a fastening bolt 13 from a side of the clamp member 12. By holding the assist handle 10, the user may firmly hold the tool and convenient to control the tool. The clamp member 12 can be loosened by unscrewing the bolt 13 and the orientation of the assist handle 10 can be adjusted and secured by screwing the bolt 13 again. Nevertheless, the operation of the bolt 13 is not convenient for the user and it takes too much time. Besides, it requires one hand holding the handle 11 and the other hand rotating the bolt 13. For most of the electric tools which are heavy and bulky, this operation processes are not convenient and cannot satisfy needs of the users.

The present invention intends to provide a assist handle that can be operated by a thumb and can be quickly fastened again.

### SUMMARY OF THE INVENTION

In accordance with one aspect of the present invention, there is provided an assist handle for electric tools wherein the assist handle comprises a handle having a connection member on an end thereof and a clamp member is pivotably connected to the connection member by a pin. A hole is defined through the clamp member so as to clamp a tool therein and a trigger is pivotably received in a recess in a side of the clamp member. The trigger is removably engaged with the connection member.

A passage is defined in communication between the hole of the clamp member and the connection member of the handle so that a locking member is received in the passage. A top end of the connection member urges against the locking member toward the tool in the hole.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional assist handle;

FIG. 2 is a side cross sectional view of the conventional assist handle;

FIG. 3 is a perspective view to show the assist handle of the present invention;

FIG. 4 is an exploded view to show the assist handle of the present invention;

FIG. 5 is a side cross sectional view of the assist handle of the present invention;

FIG. 6 shows another side view of the assist handle of the present invention;

FIG. 7A shows the handle is pivoted when the trigger is pivoted upward;

FIG. 7B shows the handle is rotated about the tool while the trigger is pivoted upward;

FIG. 8 is a side view to show the handle in FIG. 7A, and

FIGS. 9 and 10 respectively show the assist handle is used to different electric tools.

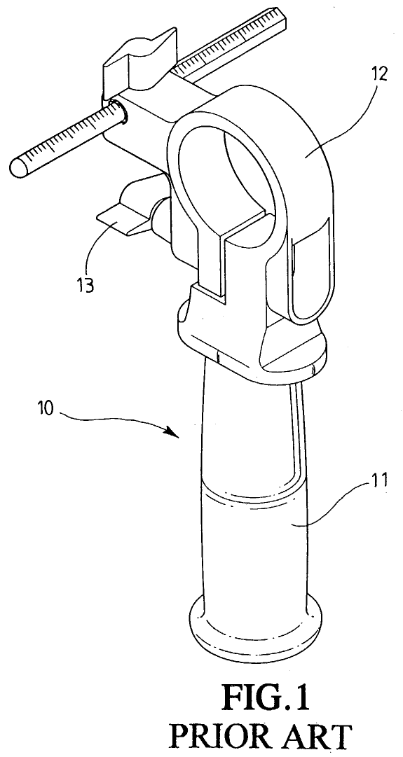

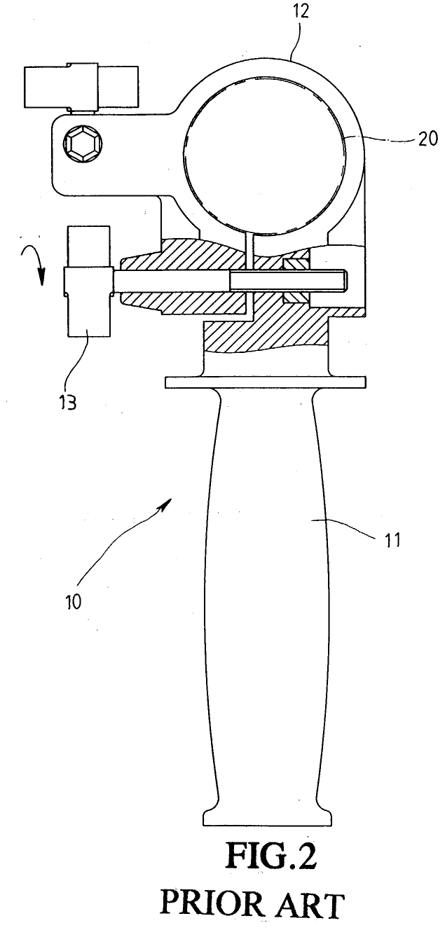

### DETAILED DESCRIPTION OF THE PREFERRED EMBODIMENT

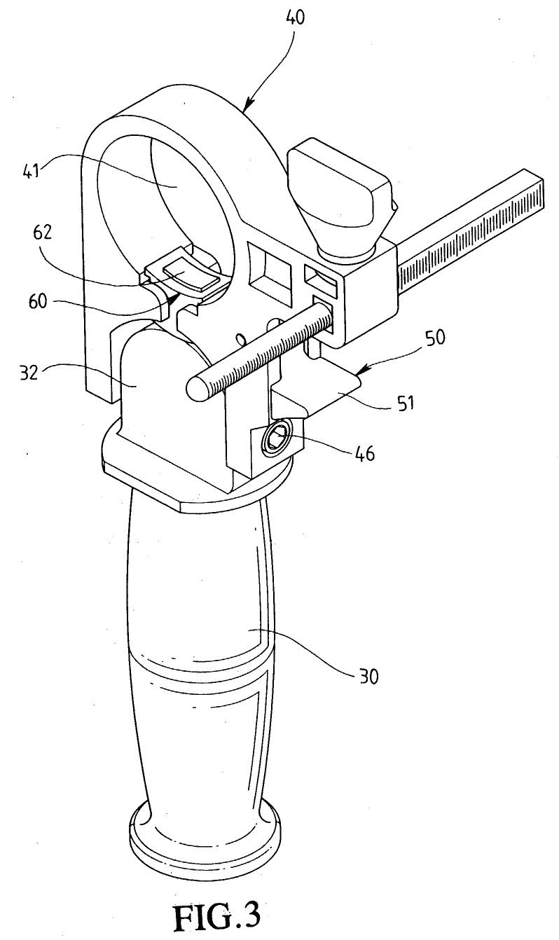

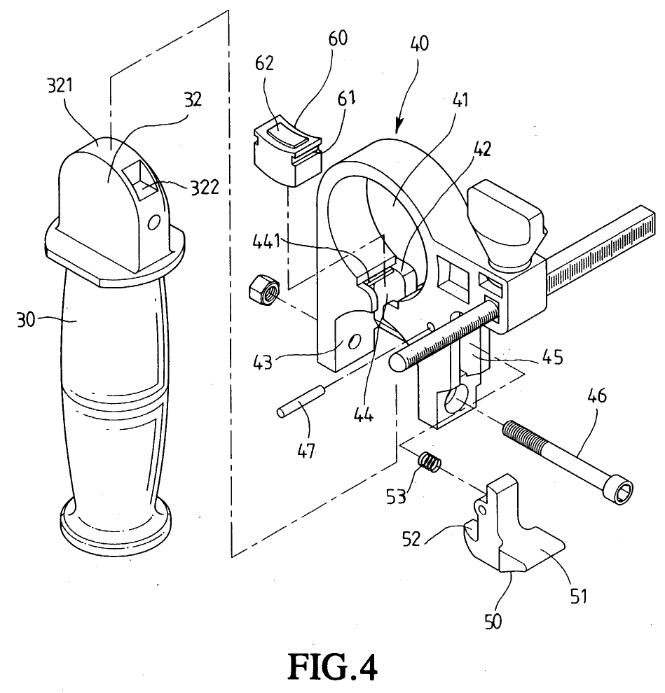

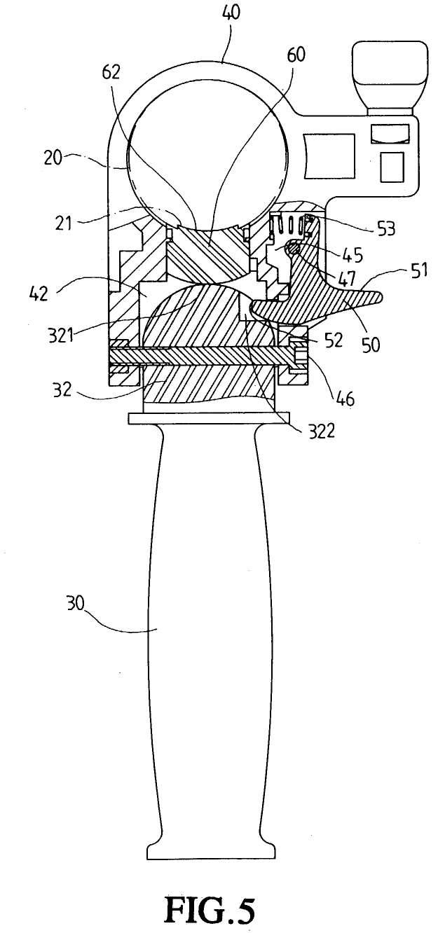

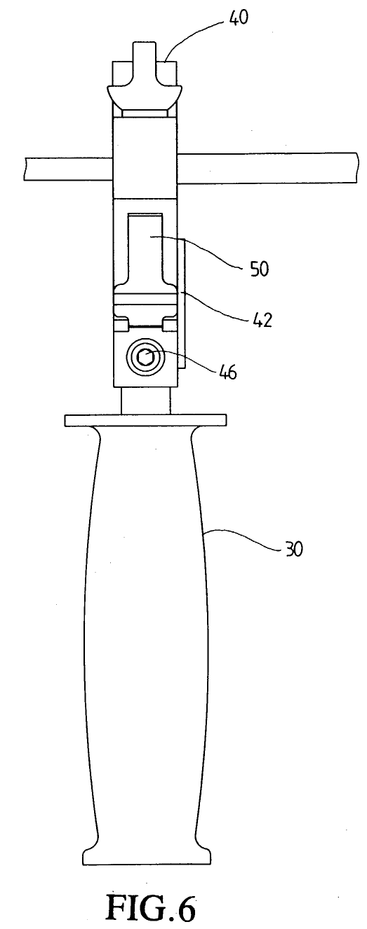

Referring to FIGS. 3 to 6, the assist handle for electric tools of the present invention comprises a handle 30 having a connection member 32 on an end thereof and the top end 321 of the connection member 32 is an arcuate surface. A notch 322 is defined in the connection member 32.

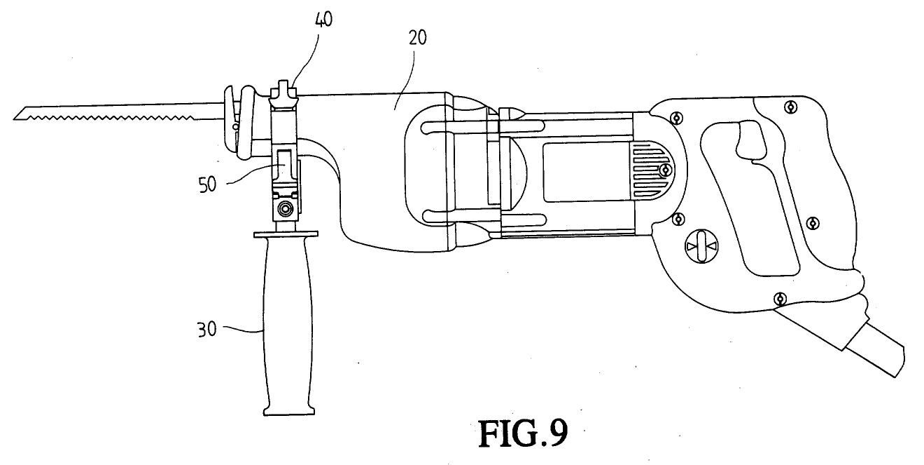

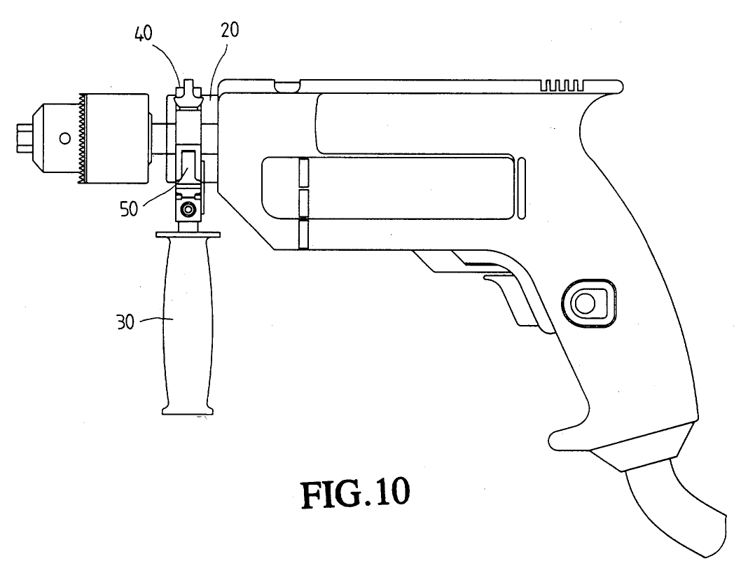

A clamp member 40 has a hole 41 defined therethrough so as to clamp the barrel of the electric tools 20 as shown in FIGS. 9 and 10. Two extensions 43 extend from the clamp member 40 and the connection member 32 is pivotably connected between the two extensions 43 by a pin 46. A recess 45 is defined in one of the extensions 43 and a trigger 50 is pivotably received in the recess 45 at pivot point thereof by a pin 47. A tongue 52 extends from an end of the trigger 50 and is removably inserted in the notch 322. A spring 53 is biased at the other end of the trigger 50 and the pivot point of the trigger 50 is located between the spring 53 and the tongue 52, so that the tongue 52 is maintain to be inserted in the notch 322 by the spring force of the spring 53. An operation portion 51 extends from the trigger 50 for the user to push it by thumb.

A passage 44 is defined by two side walls 42 and in communication between the hole 41 of the clamp member 40 and a space between the two extensions 43. Two ridges 441 extend from two insides of the passage 44 and a locking member 60 is received in the passage 44. The locking member 60 has two grooves 61 for receiving the two ridges 441 therein and a contacting pad 62 is adhered on a top of the locking member 60 so that it urges against barrel of the tool 20 without causing the surface of the tool 20 from being deformed.

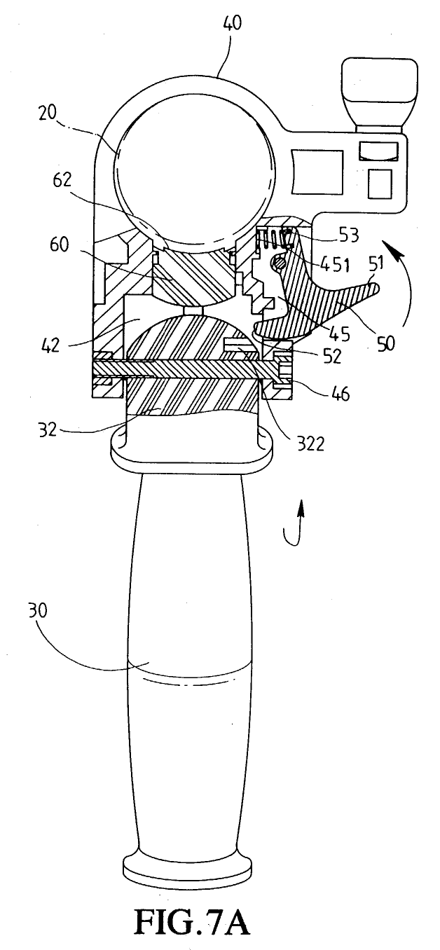

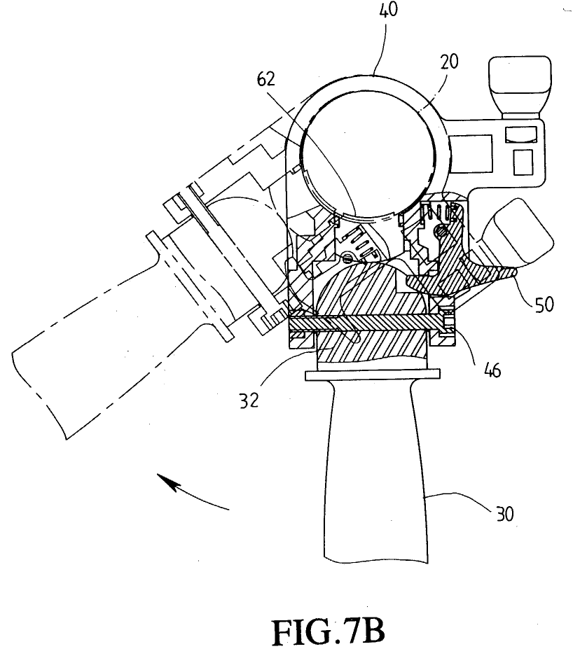

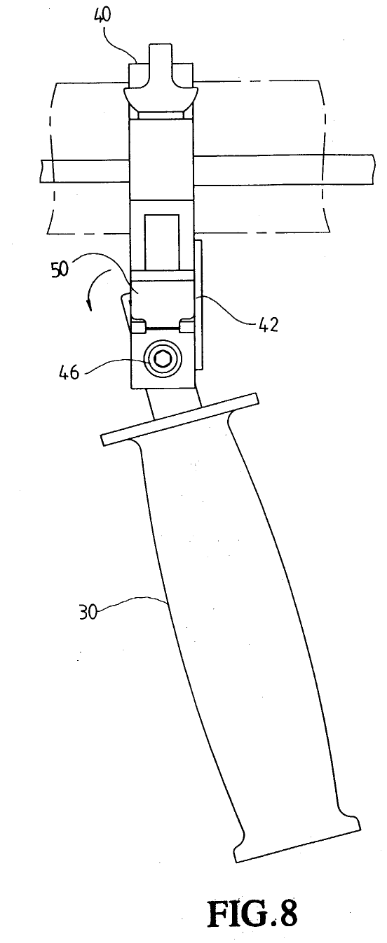

Referring to FIGS. 7A, 7B and 8, when pushing the operation portion 51 upward by thumb, the trigger 50 is pivoted and the tongue 52 is removed from the notch 322 so that the handle 30 can be pivoted about the pin 46 laterally. The pivotal movement of the handle 30 moves the connection member 32 away from the locking member 60, so that the pressure that the locking member 60 exerting onto the tool 20 is disappeared and the user can easily rotate the clamp member 40 an angle. The handle 30 is then pivoted back again and the tongue 52 is inserted in the notch 322 by releasing the operation portion 51 of the trigger 50.

While we have shown and described the embodiment in accordance with the present invention, it should be clear to those skilled in the art that further embodiments may be made without departing from the scope of the present invention.

What is claimed is:

1. An assist handle for electric tools, comprising:
a handle having a connection member on an end thereof;
a clamp member having a hole defined therethrough and two extensions, the connection member pivotably connected between the two extensions by a pin, a recess defined in one of the extensions and a trigger pivotably received in the recess at pivot point thereof, the trigger removably engaged with the connection member, and
a passage defined in communication between the hole of the clamp member and a space between the two extensions, a locking member received in the passage and a top end of the connection member urging against the locking member toward the hole.

2. The assist handle as claimed in claim 1, wherein a notch is defined in the connection member and a tongue extends from an end of the trigger and is removably inserted in the notch.

3. The assist handle as claimed in claim 2, wherein a spring is biased at the other end of the trigger and the pivot point of the trigger is located between the spring and the tongue.

4. The assist handle as claimed in claim 1, wherein two ridges extend from two insides of the passage and the locking member has two grooves for receiving the two ridges therein.

5. The assist handle as claimed in claim 1, wherein the top end of the connection member is an arcuate surface.
